(19) United States
(12) Patent Application Publication
(10) Pub. No.: US 2015/0291353 A1
(43) Pub. Date: Oct. 15, 2015

(54) GARDEN WASTE STORAGE SUPPORT STRUCTURE AND KIT

(71) Applicants: William Henry COOPER, Toronto (CA); Ronald Rene JASINSKI, Toronto (CA); Sydney BARKHOUSE, Oakville (CA); Michael YIM, North York (CA); Chi Fai CHENG, North York (CA)

(72) Inventors: William Henry COOPER, Toronto (CA); Ronald Rene JASINSKI, Toronto (CA); Sydney BARKHOUSE, Oakville (CA); Michael YIM, North York (CA); Chi Fai CHENG, North York (CA)

(21) Appl. No.: 14/448,207

(22) Filed: Jul. 31, 2014

Related U.S. Application Data
(60) Provisional application No. 61/977,856, filed on Apr. 10, 2014.

(51) Int. Cl. B65F 1/14; B62B 3/00

(52) U.S. Cl. CPC B65F 1/1415; B62B 3/002; B65F 1/1473; B65F 2240/138

(57) ABSTRACT

A kit is provided. The kit includes a garden waste storage support structure, a plurality of wheels, and a plurality of attachment members. The garden waste storage support structure includes a base, a plurality of side walls extending from the base, and a plurality of legs fixed to the base. The base comprises a plurality of integrally formed openings therein. The plurality of side walls each extend from the base. Each of the plurality of side walls comprise a plurality of integrally formed openings therein. The base and the side walls define a structure interior. The plurality of support legs are fixed to the base underneath the structure interior for at least partly elevating the base and the structure interior. The structure interior is sized to support a garden waste bag above the ground to provide for air circulation around an underside of the garden waste bag. The plurality of attachment members are for attaching one of the plurality of wheels to a respective one of the plurality of support legs for moving a garden waste bag supported by the support structure.

### CROSS REFERENCE TO RELATED APPLICATIONS

This application claims all benefit, including priority, of U.S. Provisional Patent Application Ser. No. 61/977,856, filed Apr. 10, 2014, entitled GARDEN WASTE STORAGE SUPPORT STRUCTURE AND KIT, the entire contents of which is incorporated herein by this reference.

### FIELD OF THE INVENTION

The present invention relates generally to garden waste storage. In particular, the present invention relates to garden waste storage support structures.

### BACKGROUND OF THE INVENTION

Garden or yard waste may be collected and placed into garden waste bags, such as bio-degradable garden waste bags. These bags are typically made of paper which may become wet due to moisture either in the garden waste placed within, or due to rainfall or existing moisture where the bag is placed until it is collected. When a garden waste bag becomes wet, the structural integrity of the bag may become compromised, increasing a risk of the bag ripping and the garden waste stored within spilling outside the bag when the bag is moved. Therefore there exists a need for storing or moving garden waste bags to reduce the effects of moisture on the garden waste bag and/or the contents of the garden waste bag.

### SUMMARY OF THE INVENTION

In accordance with an aspect of the present invention, a kit is provided. The kit includes a garden waste storage support structure, a plurality of wheels, and a plurality of attachment members. The garden waste storage support structure includes a base, a plurality of side walls extending from the base, and a plurality of legs fixed to the base. The base comprises a plurality of integrally formed openings therein. The plurality of side walls each extend from the base. Each of the plurality of side walls comprise a plurality of integrally formed openings therein. The base and the side walls define a structure interior. The plurality of support legs are fixed to the base underneath the structure interior for at least partly elevating the base and the structure interior. The structure interior is sized to support a garden waste bag above the ground to provide for air circulation around an underside of the garden waste bag. The plurality of attachment members are for attaching one of the plurality of wheels to a respective one of the plurality of support legs for moving a garden waste bag supported by the support structure.

In accordance with another aspect of the present invention, there is provided a garden waste storage support structure comprising: a base comprising a plurality of integrally formed openings therein; a plurality of side walls extending from the base, each of the plurality of side walls comprising a plurality of integrally formed openings therein, the base and the side walls defining a structure interior; and a plurality of support legs fixed to the base underneath the structure interior for at least partly elevating the base and the structure interior; wherein the structure interior is sized to support a yard waste bag.

In this respect, before explaining at least one embodiment of the invention in detail, it is to be understood that the invention is not limited in its application to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments of the invention are illustrated by way of example. It is to be expressly understood that the description and drawings are only for the purpose of illustration and as an aid to understanding, and are not intended as a definition of the limits of the invention.

FIG. 1 illustrates a front isometric view an implementation of the garden storage support structure of the present invention.

FIG. 2 illustrates a front elevation view of the structure of FIG. 1.

FIG. 3 illustrates a side elevation view of the structure of FIG. 1.

FIG. 4 illustrates a top plan view of the structure of FIG. 1.

FIG. 5 illustrates a rear elevation view of the structure of FIG. 1.

FIG. 6 illustrates a front isometric view of an implementation of an assembled garden storage support structure kit of the present invention.

FIG. 7 illustrates a front isometric view of an implementation of an unassembled garden storage support structure kit of the present invention.

FIG. 8 illustrates a front isometric view of an implementation of an unassembled garden storage support structure kit of the present invention.

FIG. 9 illustrates a rear elevation view of an implementation of a wheel of the garden storage support structure of the present invention, in accordance with an aspect of the present invention.

FIG. 10 illustrates a sectional view along section A-A of the wheel of FIG. 9.

FIG. 11 illustrates a side elevation view of the wheel of FIG. 9.

FIG. 12 illustrates a front elevation view of the wheel of FIG. 9.

FIG. 13 illustrates a front perspective view of the wheel of FIG. 9.

FIG. 14 illustrates a rear perspective view of the wheel of FIG. 9.

FIG. 15 illustrates a side elevation view of an implementation of a wheel attachment member of the garden storage support structure of the present invention, in accordance with an aspect of the present invention.

FIG. 16 illustrates a sectional view along section B-B of the wheel attachment member of FIG. 15.

FIG. 17 illustrates a rear perspective view of the wheel attachment member of FIG. FIG. 15.

FIG. 18 illustrates a front perspective view of the wheel attachment member of FIG. 15.

### DETAILED DESCRIPTION

This invention describes a garden waste storage support structure. The structure. The structure may be provided on its own or packaged as a kit with additional components.

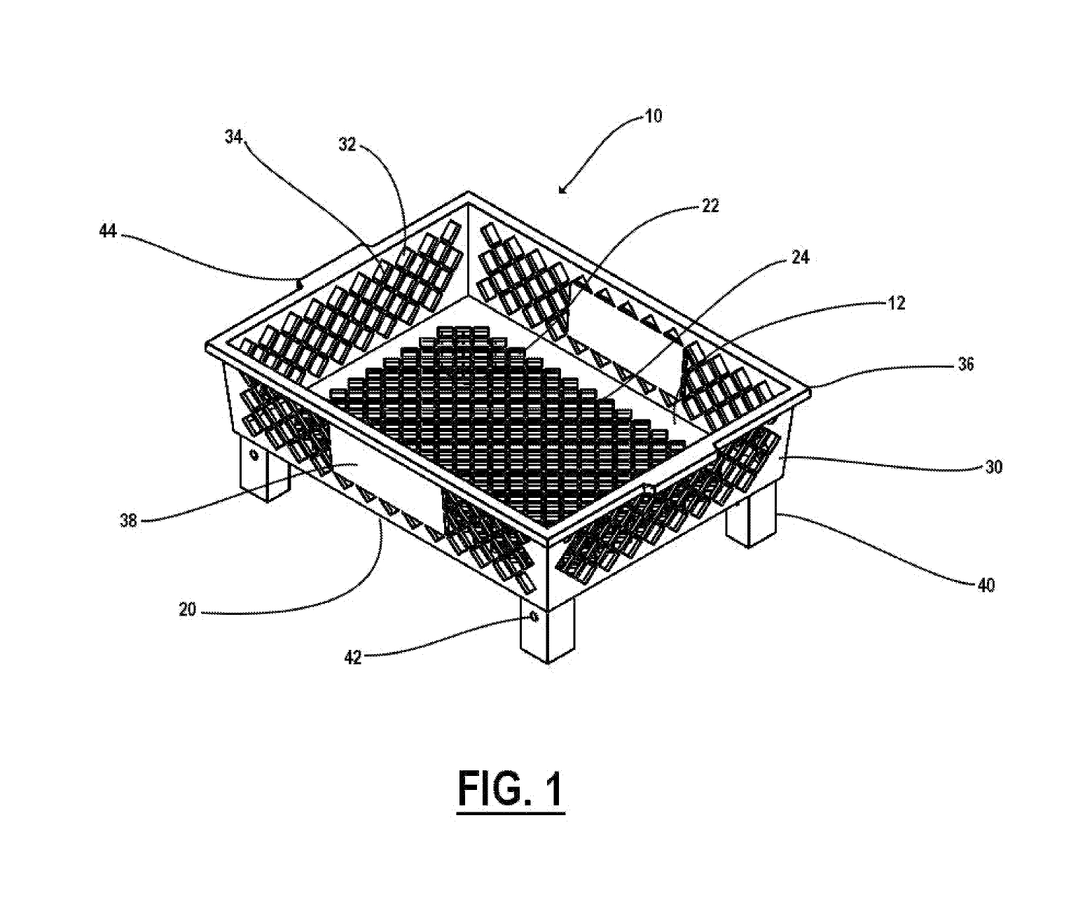

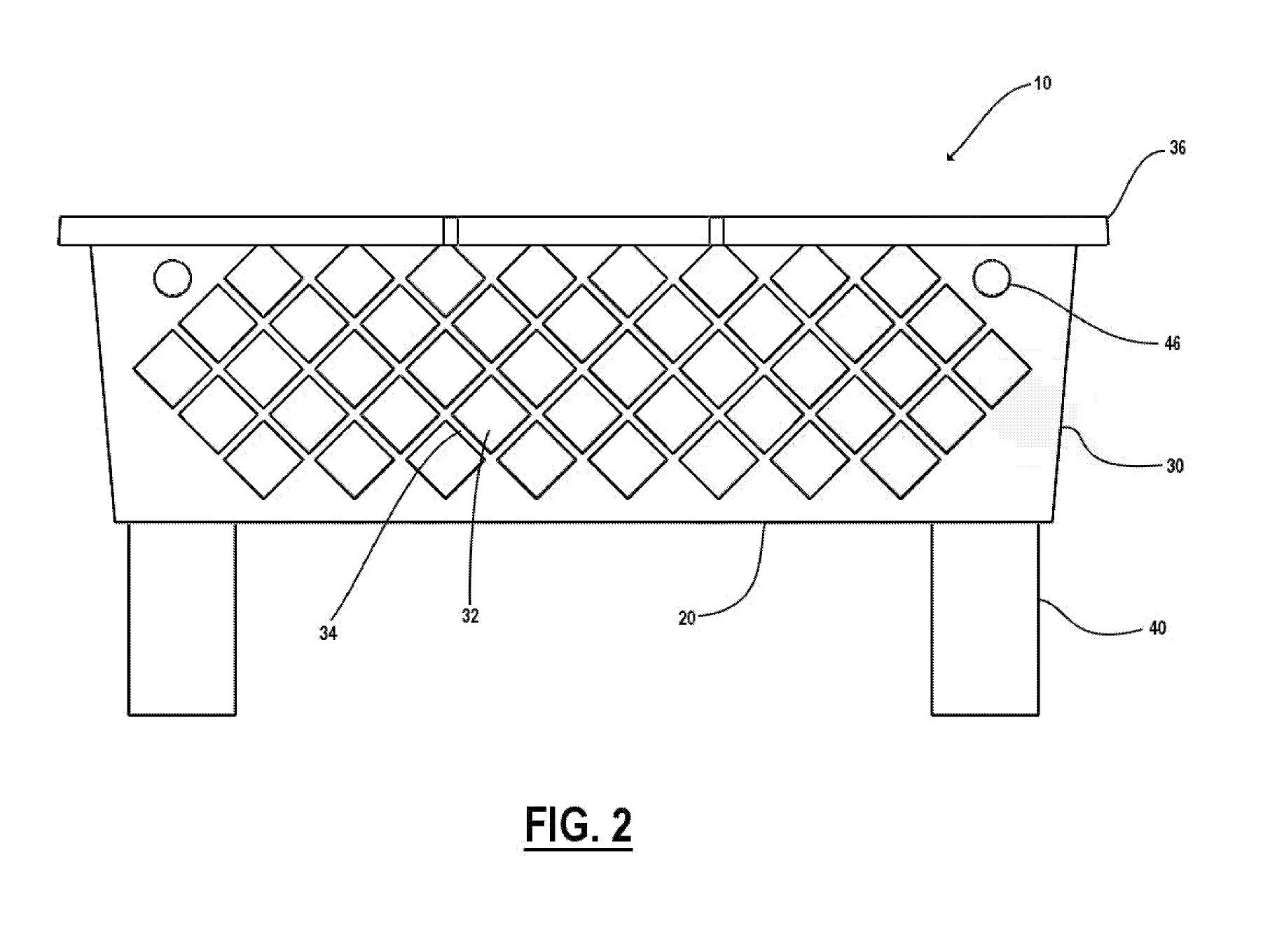

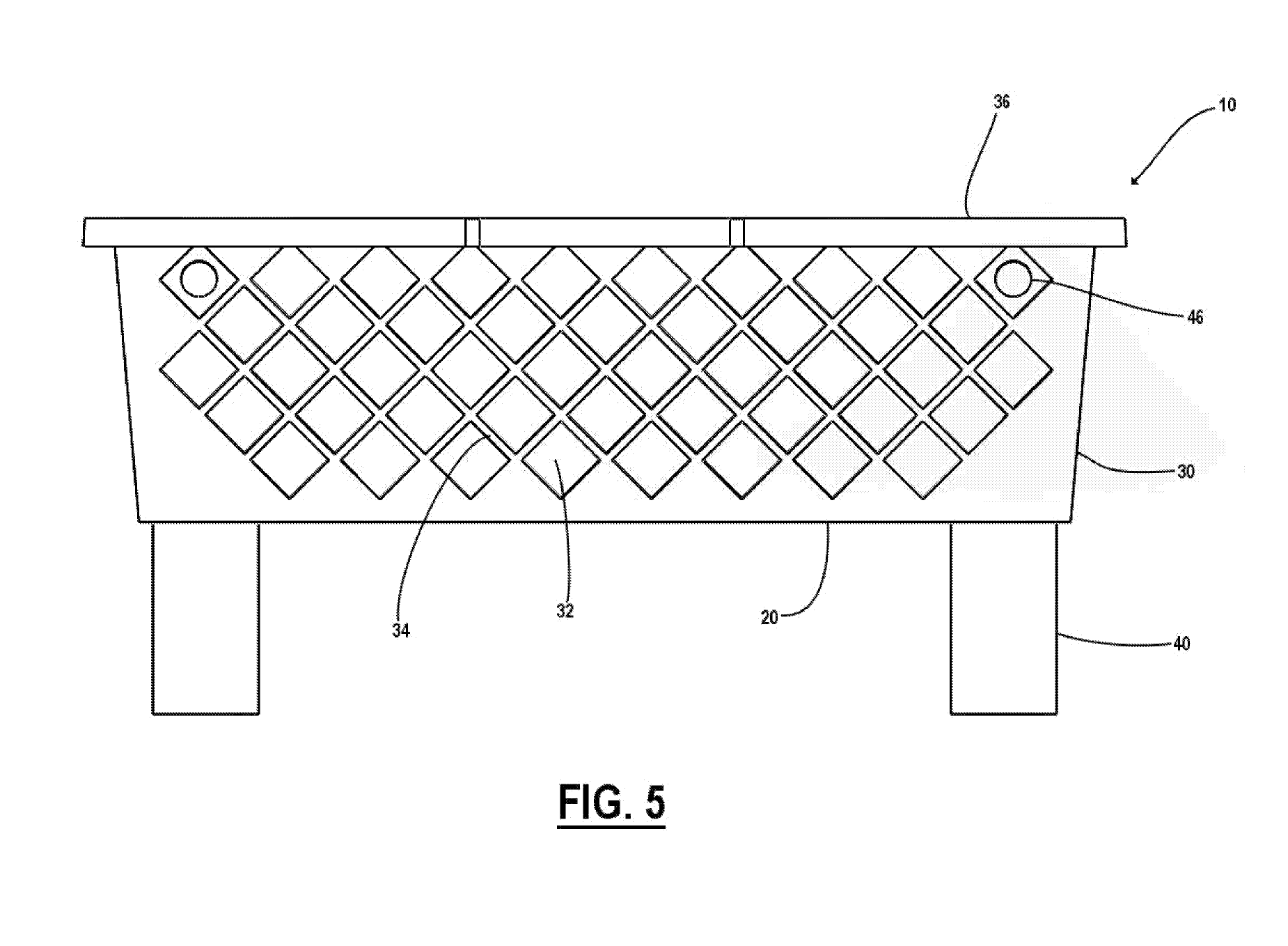

With reference to FIGS. 1 to 5, the structure 10 comprises a base 20, a plurality of side walls 30 extending from the base 20, and a plurality of legs 40 fixed to the base 20. The base 20 comprises a plurality of openings 22 integrally formed therein. The plurality of side walls 30 each extend upwardly from the base 20 as shown. Each of the plurality of side walls 30 comprise a plurality of integrally formed openings 32 therein. The base 20 and the side walls 30 define a structure interior 12. The plurality of support legs 40 are fixed to the base 20 underneath the structure interior 12 for at least partly elevating the base 20 and the structure interior 12. The structure interior 12 is sized to support a yard waste bag (not shown) above the ground (or any surface upon which the structure 10 rests, to provide for air circulation around at least an underside of the yard waste bag.

The openings 22 and 32 are formed into the structure 10 in order to provide for air circulation through the base 10 and the side walls 30. The legs 40 further provide for air circulation through the base 10 by elevating the structure 10 above the ground. A problem encountered with storing a garden waste bag at least partially full of garden waste, is that the bag may be wet by virtue of moisture included with the garden waste stored thereon or by virtue of subsequent rainfall or ground moisture where the bag is placed until it is removed from the premises. Normally, when a garden waste bag becomes wet, it may not fully dry, even after remaining in dry conditions for several days. The structural integrity of the bag may become weakened such that when it comes time to move the bag, which may still be wet, the bag may rip, or the bottom may open up or fall off, and garden waste stored therein may spill out. By elevating the bag with the structure 10 of the present invention, the bag may be kept away from surface moisture, and the bag may be provided with air circulation under and around the bag in order to allow the bag to dry if it is wet or becomes wet.

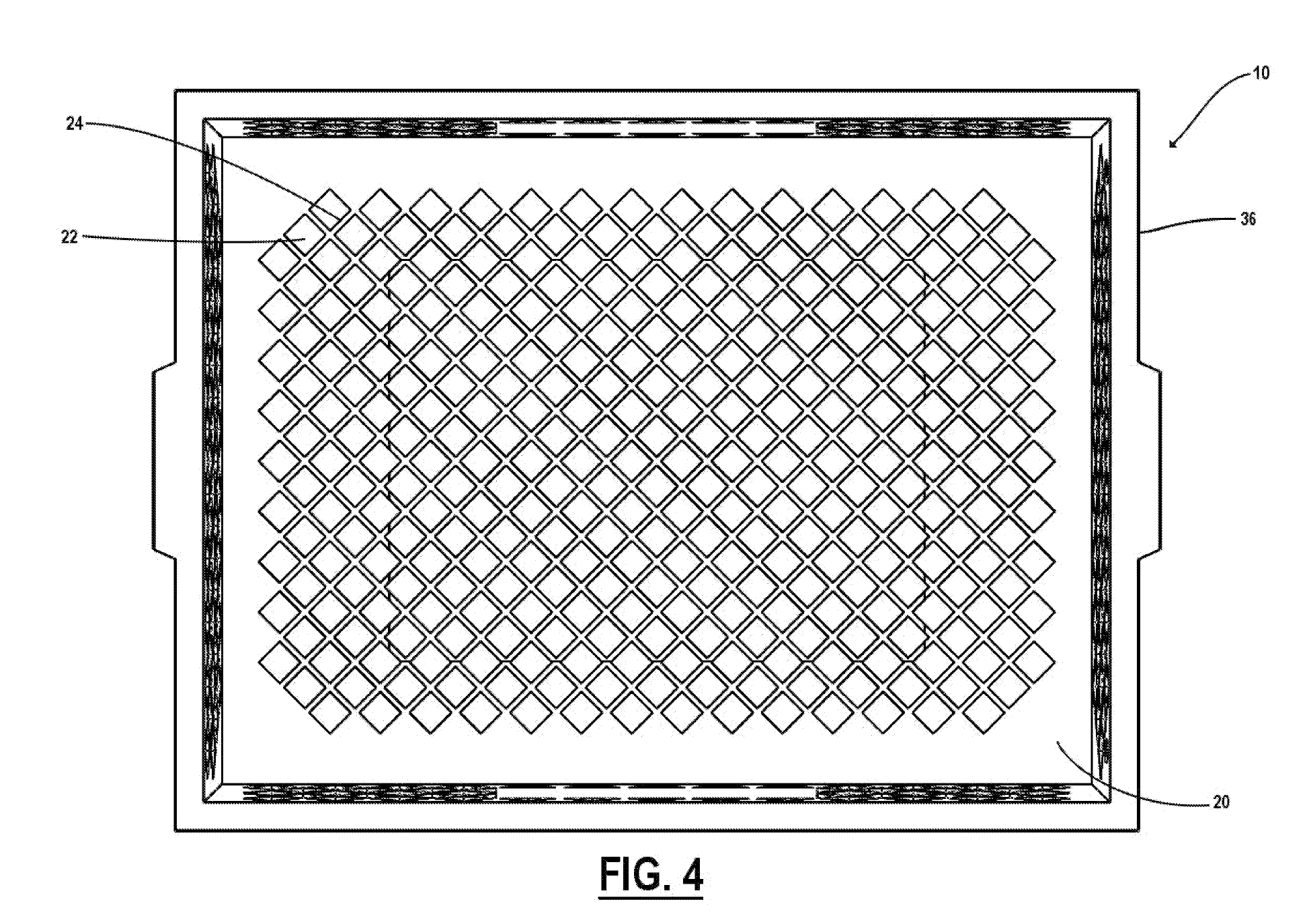

The openings 22 in the base 10 may be defined by intersections of a plurality of intersecting planar support members 24 integrally formed into the base 10, as shown in FIGS. 1 and 4. The openings 22 may be of a substantially uniform size and shape as shown or may vary in size so long as the base 10 remains capable of supporting a standard size garden waste bag placed thereon. The support members 24 may span diagonally, or at various angles, across the base 10. Optionally, the support members 24 may be angled to one another at ninety-degree or right angles such that at least some of the support members 24 are parallel to side edges of the base 10. Optionally, the support members 24 may not intersect at all. For example, the support members 24 may only be oriented parallel to one side of the base 10. However, the support members 24 in such an arrangement may need to be made thicker in order to continue to support the weight of a standard garden waste bag when filled with garden waste that may be wet.

Similarly, the openings 32 in each of the side walls 30 may be defined by intersections of a plurality of intersecting planar support members 34 integrally formed into the side walls 30, as shown in FIGS. 1, 2, 3, and 5. The openings 32 may be of a substantially uniform size and shape as shown or may vary in size so long as the side walls 30 remain capable of remaining stable when a standard size garden waste bag is placed on the base 10, and may lean against one or more of the side walls 30. The support members 34 may span diagonally, or at various angles, across the side walls 30. Optionally, the support members 34 may be angled to one another at ninety-degree or right angles such that at least some of the support members 34 are parallel to ends of the respective side wall 30 or to the base 10. Optionally, the support members 34 may not intersect at all. For example, optionally, the support members 34 may only be oriented parallel to ends of the respective side wall 30 or to the base 10, but not both. However, the support members 34 in such an arrangement may need to be made thicker in order to continue to support the side wall 30 in the position shown in FIG. 1 when a standard garden waste bag when filled with garden waste that may be wet is placed on the base 10.

Although the structure 10 is shown having four side walls 30 of equal height, the side walls 30 may be of varying height(s), and one or more of the sides of the structure 10 may not necessarily feature a side wall. There structure 10 may also include one or more additional wall elements, such as one or more divider walls (not shown) extending upwards from the base 10 at an intermediary position between ends of the structure 10. The structure 10 may accordingly be sized to accommodate more than one garden waste bag by sizing the surface area of any interior space(s) defined by the divider wall and the side walls 30 to each fit one or more garden waste bags. Similarly, while four legs 40 are shown, there may be more than four legs, with legs being positioned at intermediate positions between corners of the structure 10. In particular in implementations where the structure 10 is sized to accommodate a plurality of garden waste bags, more than four legs 40 may be attached to the base 10.

Optionally, each leg 40 may be at least approximately 2 inches high. Optionally, each leg 40 may be at least approximately 2 inches wide, and 2 inches thick.

In various non-limiting implementations of the present invention, at least the base 10 and the side walls 30 of the structure 10 may be integrally molded from a polymer such as a thermoplastic, thermoset, or elastomer. For example, the base 10 and the side walls 30 may be made of polypropylene. The legs 40 may also be made in this way, either molded together with the base 10 and side walls 30 or separately and later fixed to the base 10 by glue, epoxy resin, or other adhesive, or by a fastening means such as a screw.

The side walls 30 may feature a flange 36 as shown in FIG. 1 surrounding a top circumference of the structure 10. Optionally, one or more handles 44 may be provided in the flange 36 or at other positions on the side walls 30. The handles 44 may be of any shape or configuration. For example, the handles 44 may be integrally molded with the flange 36 and the side walls 36. For example, the handles 44 may be made of a bent material, such as a metal rod, and may be pivotally attached to the side walls 30 at respective attaching points, such as attachment apertures formed into the side walls 30. Optionally, the structure interior 12 may be positioned at a depth of about 4 inches to about 4.5 inches from the flange 36.

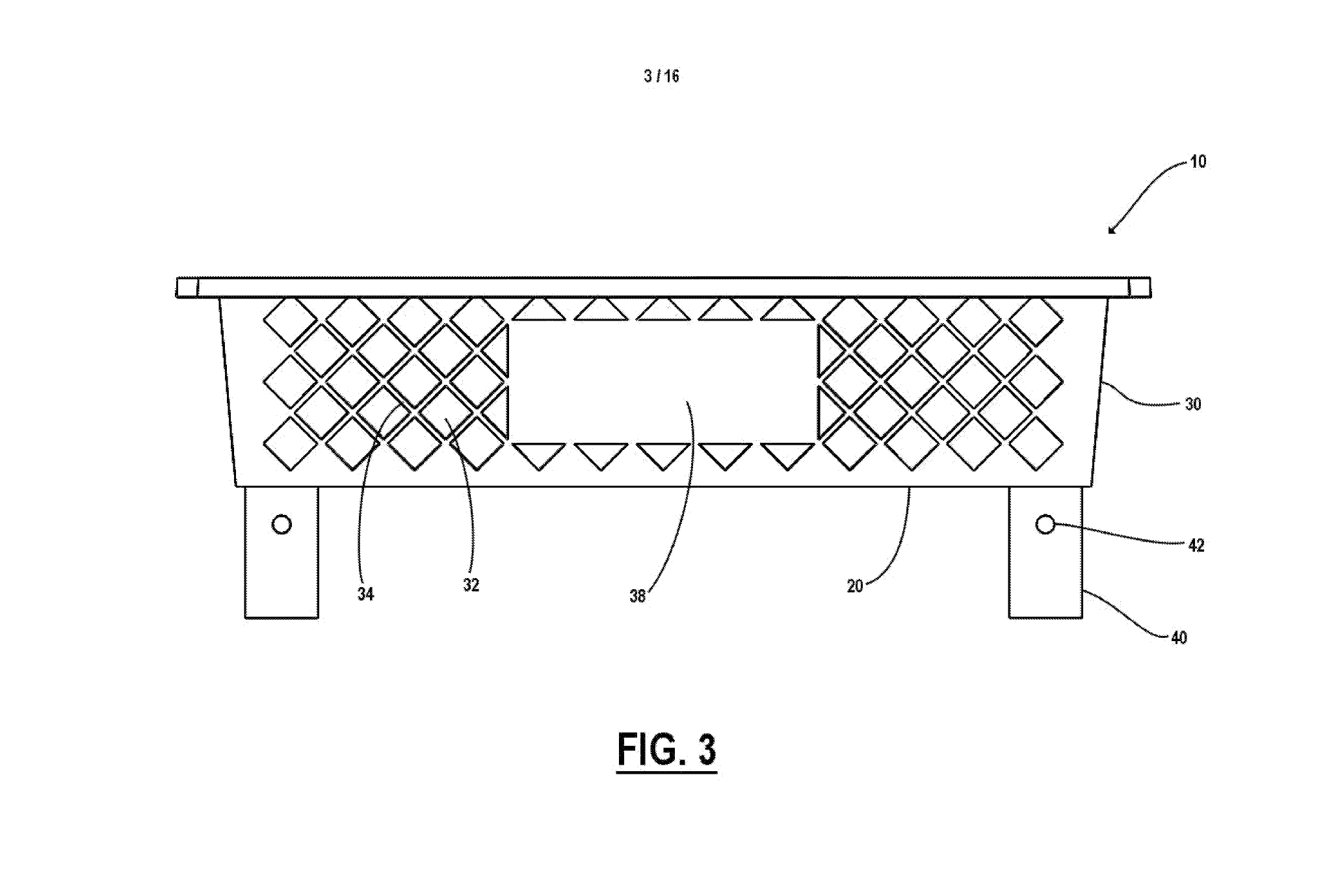

One or more of the side walls 30 may include a wall face 38 as shown in FIGS. 1 and 3 which may be used to attach a label thereto. For example, the wall face 38 may be a substantially uniform surface to provide for a label to readily adhere to the face 38 or to provide for a surface upon which to write characters, such as letters, words, numbers or symbols in order to identify the structure 10 or for marketing purposes. The wall face 38 may be any size or shape and there may be more than one face 38 on a given side wall 30. Preferably, the face 38 does not occupy the entirety of a given wall 38, such that air circulation through the respective side wall 30 may be maintained. Optionally, the wall face 38 may have surface area dimensions of about 6.403 inches by about 2.551 inches.

Optionally, the side walls 30 may be angled away from the base 20 at a ninety degree angle, or at a more than a ninety degree angle (such as between 90 degrees and 135 degrees, or at any angle between 90 degrees and 180 degrees so long as the angle of connection between the side walls 30 and the base 20 is sufficient to support a garden waste bag on the base 20 without falling off of the structure 10. Accordingly, each side wall may be angled at a different angle with respect to the base 20. One advantage of angling the side walls 30 at least slightly greater than 90 degrees is to provide for multiple structures 10 to be nested or stacked, one on top of another. To further accommodate nesting of structures 10, optionally, the legs 40 may also be respectively angled in accordance with the angle of the respective side wall 30 proximate the respective leg 40. Optionally, each leg 40 may include a tapered corner edge and proximate leg sides near the corner in order to better nest the respective leg inside a structure 10 when nesting or stacking the structures 10. Optionally, the tapered portion of the leg 40 may extend only along a part of the tapered corner, effectively by cutting out a triangular-like portion of the corner of the leg, in order to maintain any rigidity of the leg and maintaining a ground-contacting surface area of the leg that is sufficient to support the weight of the structure 10 and any garden waste bag supported by the structure 10. Optionally, any tapering of the legs 40 would provide for a surface area of at least 1.75 inches square at each leg 40 to contact the ground. Optionally, any tapering of the legs 40 would provide for a surface area of at least 1.5 inches square at each leg 40 to contact the ground. Optionally, any tapering of the legs 40 would provide for a surface area of at least 1.25 inches square at each leg 40 to contact the ground. Optionally, any tapering of the legs 40 would provide for a surface area of at least 1 inch square at each leg 40 to contact the ground.

Optionally, the structure 10 may have external surface area dimensions of about 14.761 inches by about 19.209 inches. Each handle 44 may extend out from the structure 10 by about 0.432 inches, and may be tapered at angles of approximately 48.9 degrees from the structure 10. Each handle may be approximately 3.542 inches long.

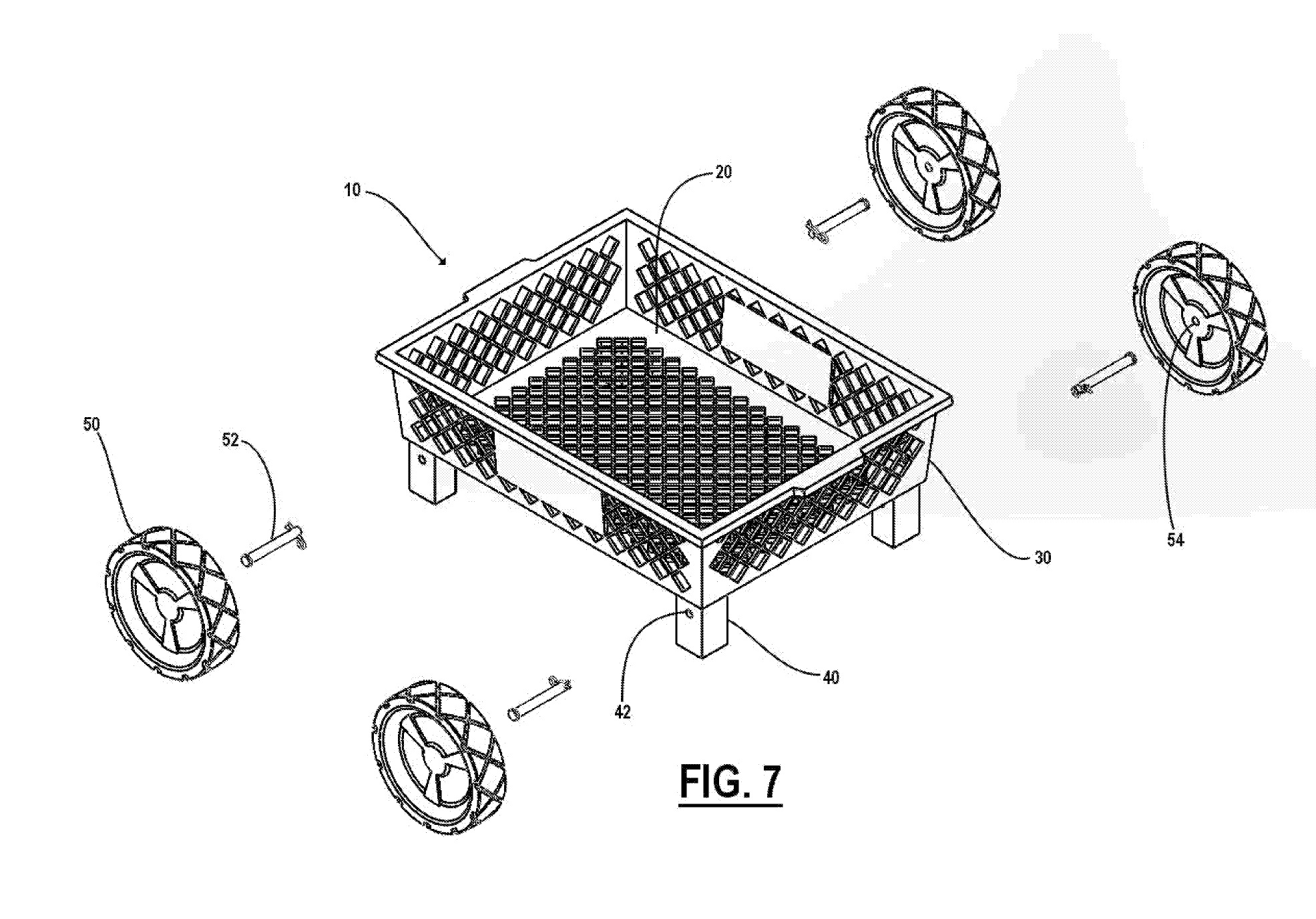

The structure 10 may be provided alone or it may be provided as part of a kit. An embodiment of an unassembled kit including the structure 10 is shown in FIG. 7. The kit may include the structure 10, a plurality of wheels 50, and a plurality of attachment members 52. Each attachment member 52 may be configured to attach one of the plurality of wheels to a respective one of the plurality of legs 40.

Each of the plurality of legs 40 may comprise a mounting aperture 42 bored laterally therethrough. Each attachment member 52 may be sized to fit through the respective mounting aperture 42.

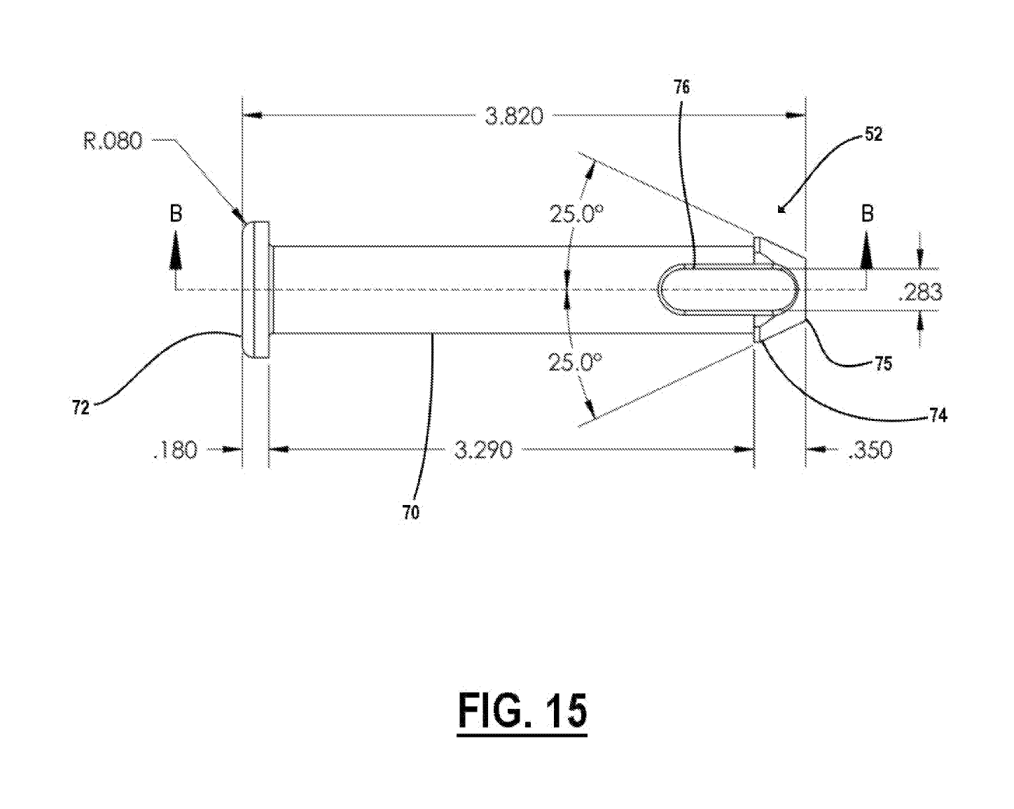

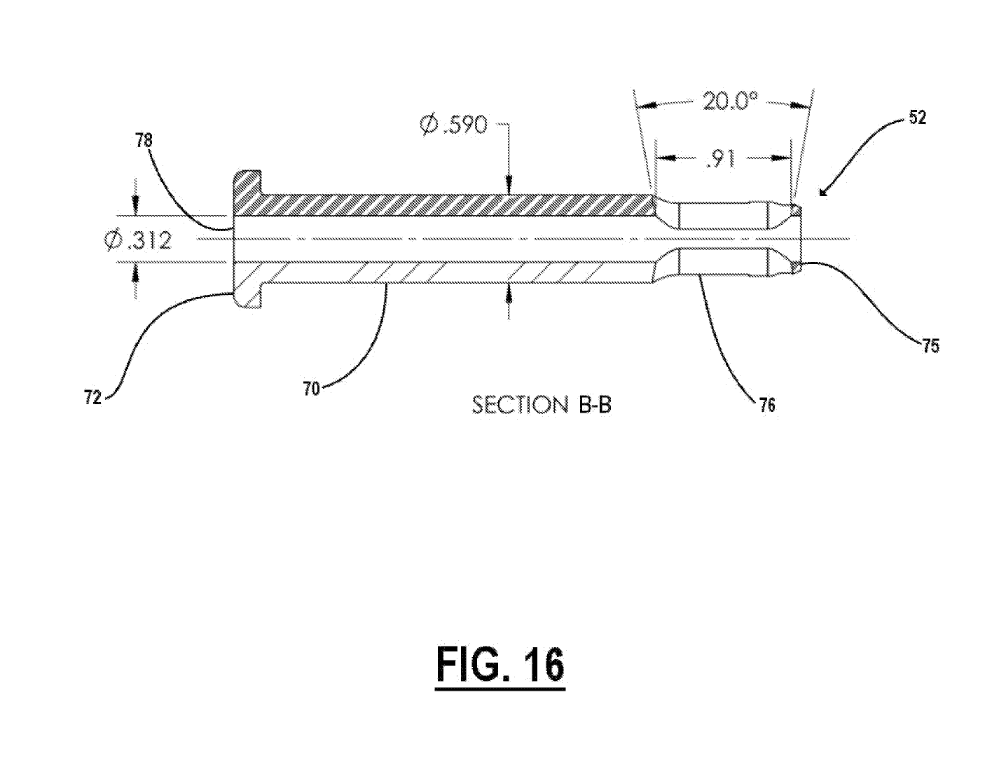

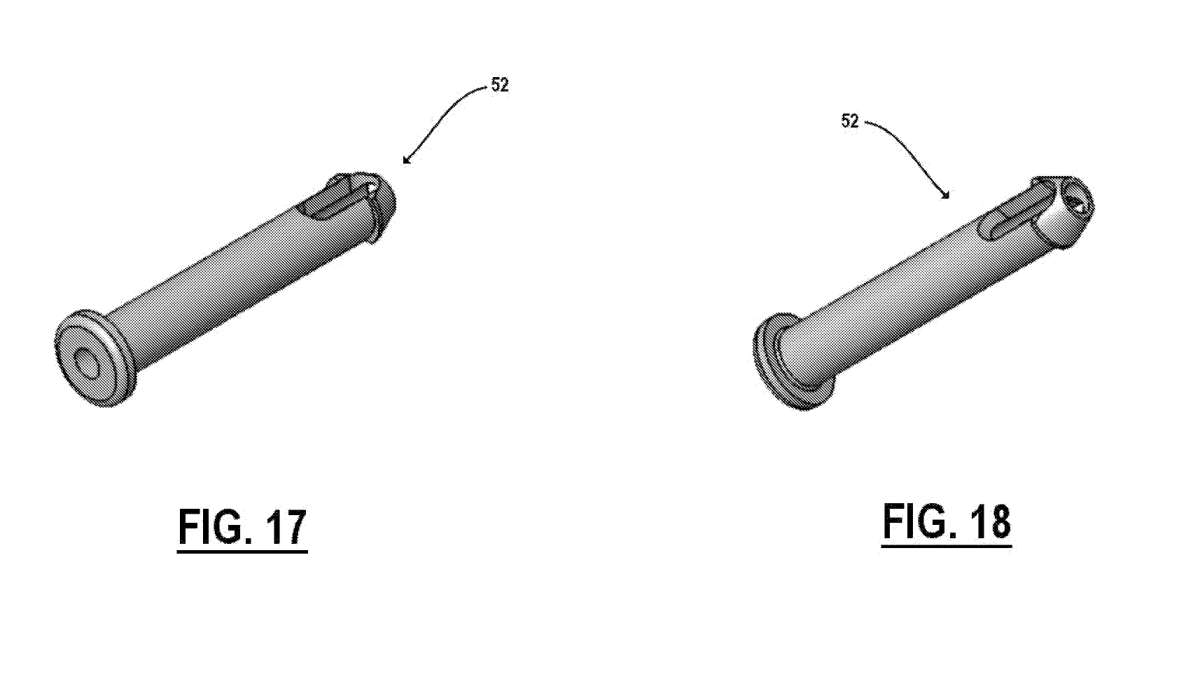

The attachment members 52 may take various forms. For example, at least one of the attachment members 52 may include a clevis pin, a cotter pin, a screw, a nut with a bolt, or any other type of pin or attachment means that would allow for the attachment member to rotate or for a wheel attached to the attachment member to rotate. The attachment member 52 is also securable to each of the wheels 50 at attachment point 54, which may comprise an aperture or cavity in the wheel 50 as shown in FIG. 7. The attachment members 52 may be made of steel, aluminum, or other metals, or a plastic such as polyacetone. An exemplary, non-limiting attachment member 52 is shown in FIGS. 15 to 18. The attachment member 52 may be about 3.820 inches long. The attachment member 52 may comprise an elongate shaft 70 terminated at either end by a stop 72 and a tip 75. Elongate aperture 78 may extend from stop 72 to tip 75, as shown in FIG. 16. The tip 75 may comprise a flanged portion 74 surrounding at least one elongate opening 76. Elongate opening 76 is located proximate tip 75 and, together with elongate aperture 78, may provide for deformation of tip 75 when compressed at flanged portion 74 when inserted into a mounting aperture 42 of structure 10. The flanged portion 74 may serve to press against a surface of a respective leg 40 once attachment member 52 is fully inserted into the respective mounting aperture 42. The length of the elongate opening 76 may be about 0.91 inches. The diameter of the elongate aperture 78 may be about 0.312 inches. The flanged portion 74 may measure about 0.350 inches along the length of the elongate shaft 70 from the tip 75, and may flange outwardly at angles of approximately 25 degrees from the elongate shaft 70 as shown in FIG. 15. A section B-B is marked in FIG. 15, and the section B-B is shown in FIG. 16, showing further details of this implementation of the attachment member 52.

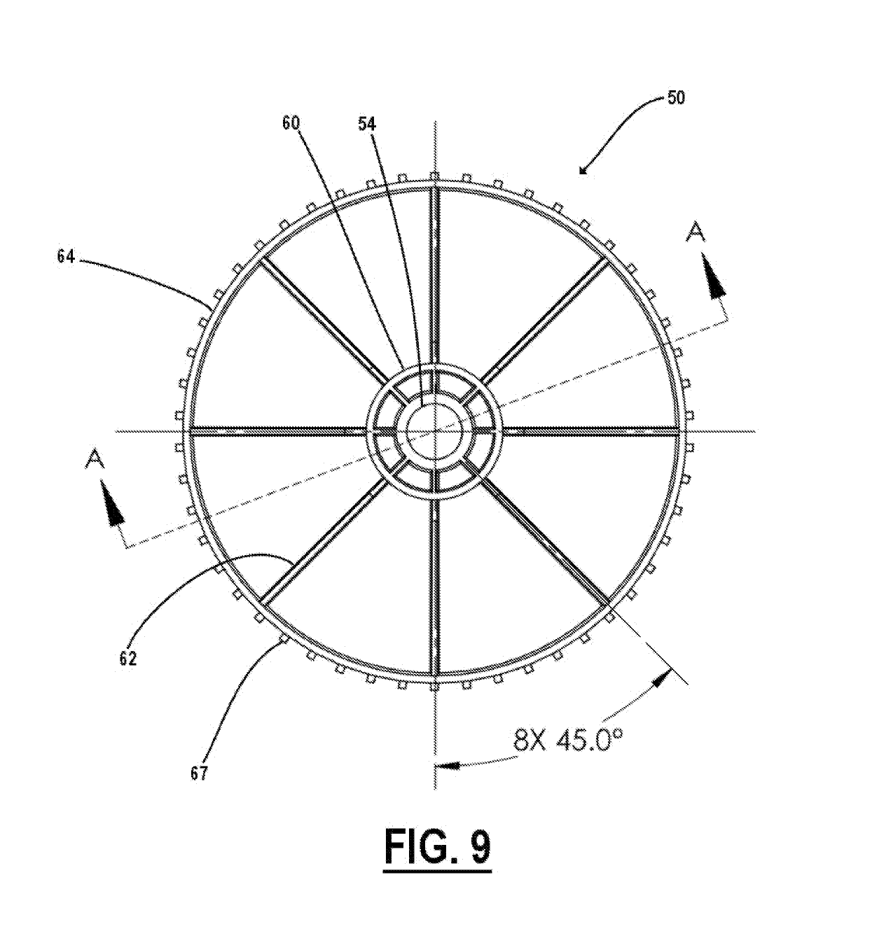

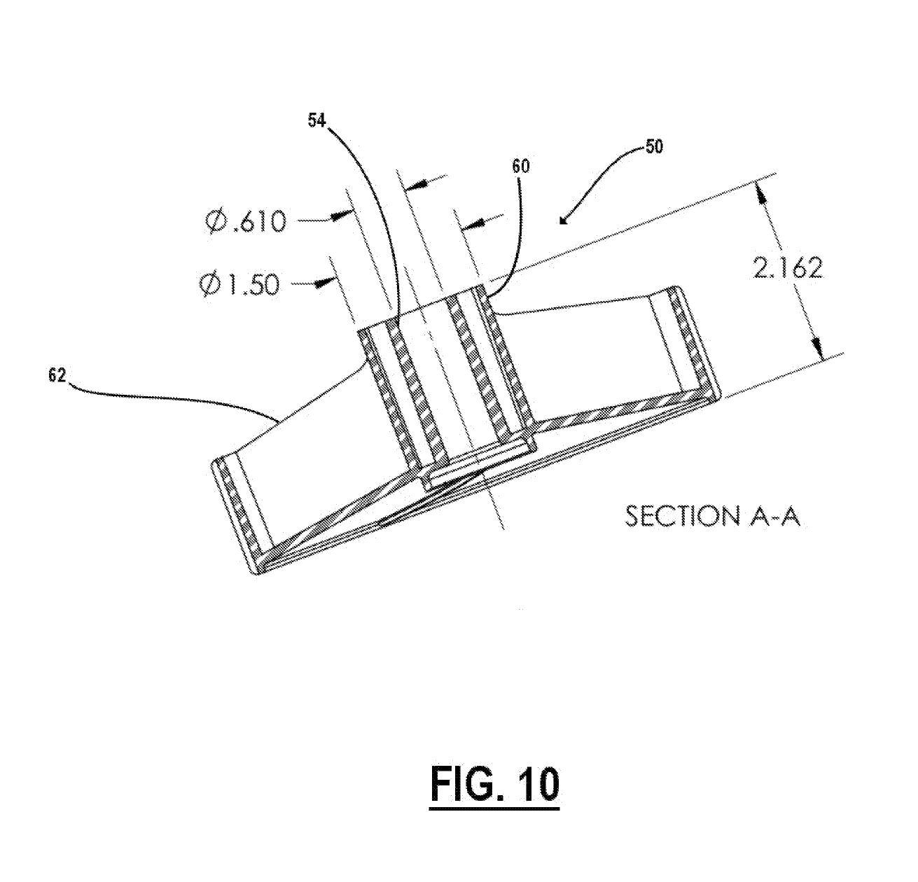

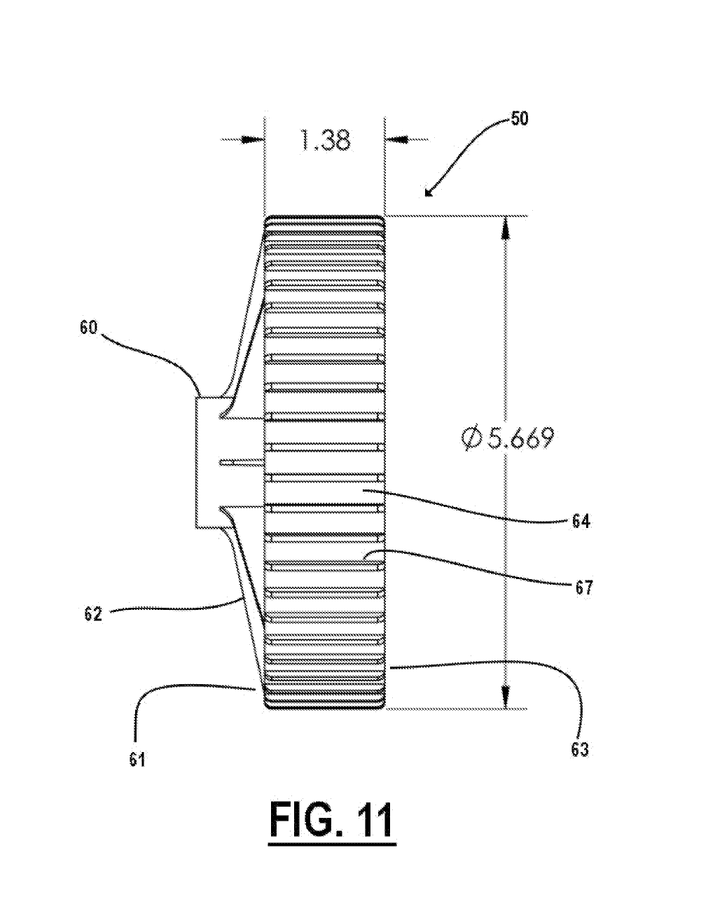

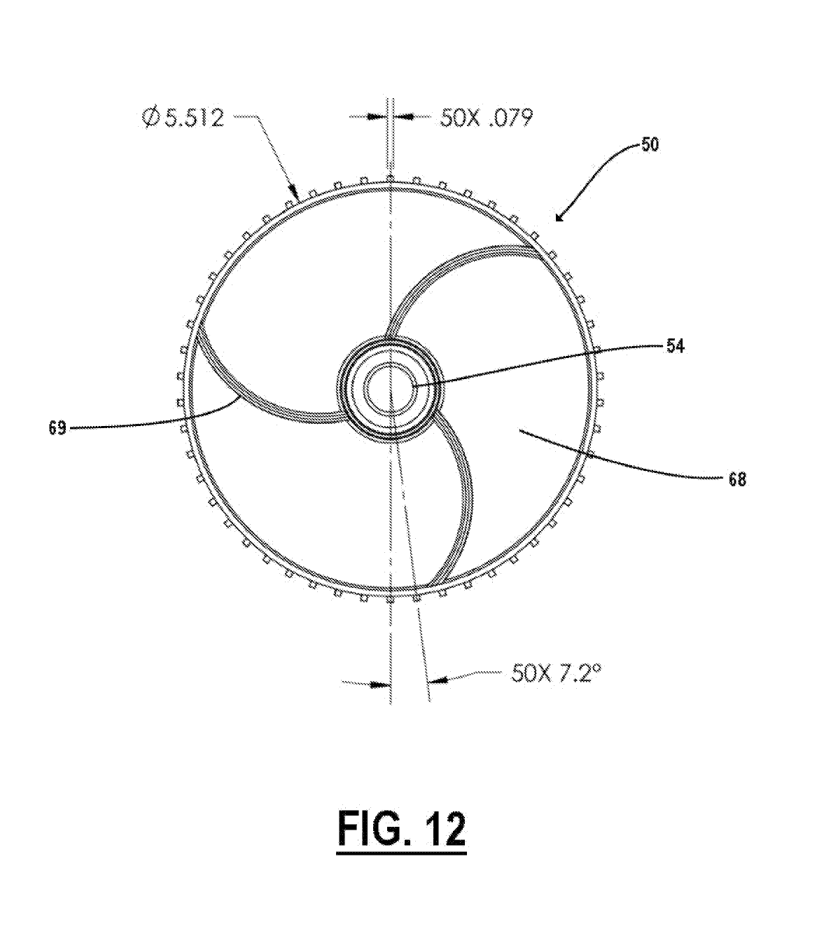

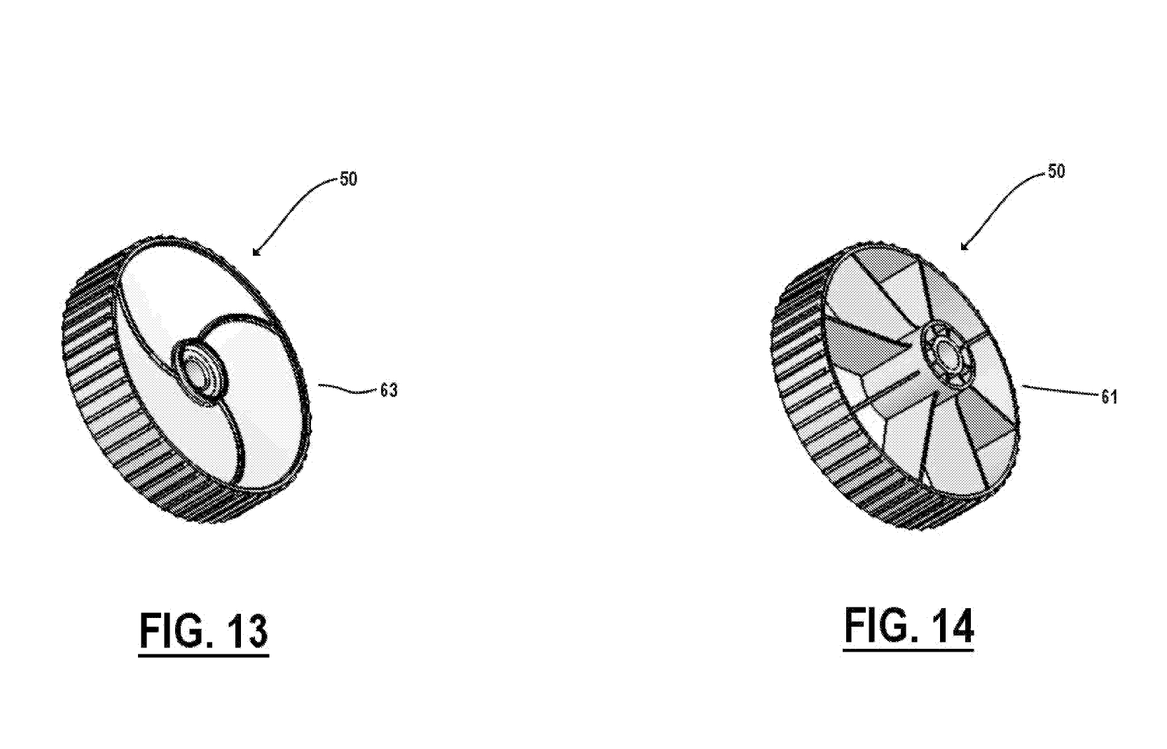

Many sizes and configurations of wheels 50 are possible. An implementation of wheel 50 is shown in FIGS. 9 to 14. FIG. 9 shows rear side 61 of wheel 50. Wheel 50 may comprise a hub 60 from which a plurality of support members 62 may extend outwardly towards and to support tread 64. The tread 64 may comprise a plurality of outward-facing projections 67 that may be arranged in a parallel configuration to one another as shown, or in other configurations. The hub 60 may be spaced radially outwardly from attachment point 54, shown as an elongate aperture concentric with hub 60. A section A-A is marked in FIG. 9, and the section A-A is shown in FIG. 10, showing further details of this implementation of the wheel 50. The hub 60, may extend further out the rear side 61 of wheel 50 than the support members 62, as shown in FIGS. 10 and 11 so that the support members 62 and the tread 64 is spaced from the rest of the structure 10 when attached thereto, reducing resistance between the structure 10 and the wheel 50 when the wheel 50 is rolling. For example, the hub 60 therefore may have a width of about 2.162 inches. Optionally, the support members 62 may be angled at about 45 degrees with respect to one another, thereby providing for a total of eight support members per wheel 50. Optionally, the tread 64 may have a width of about 1.38 inches, as shown in FIG. 11. Optionally, the wheel may have a total height of about 5.669 inches. Optionally, each projection 67 may be angled at about 7.2 degrees with respect to one another, thereby providing for a total of 50 projections 67 per wheel, as shown in FIG. 12. Each projection 67 may be about 0.079 inches wide, and 1.38 inches deep, and may extend over substantially the width of the tread 64. As shown in FIG. 12, at the front side 63 of wheel 50, there may be a front wheel surface 68 separated into front wheel surface portions by support members 69. Support members 69 may extend radially from hub 60 to tread 64 or may extend in a spiral fashion, as shown, or in other configurations.

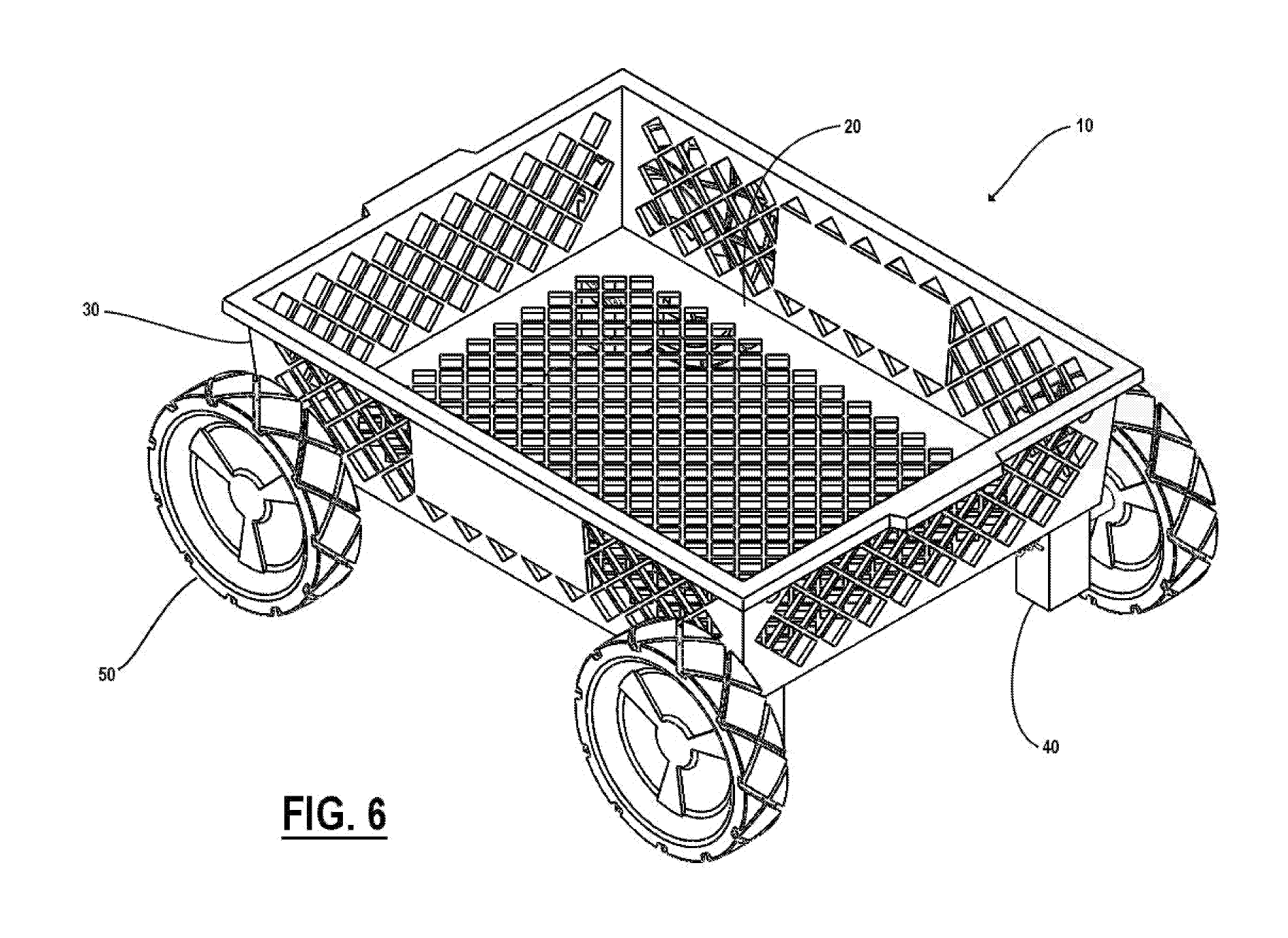

The kit may also include a pull strap (not shown), such as a rope, or cord, string, or any other type of flexible or inflexible strap. The structure 10 when included in the kit or on its own may optionally include at least one strap anchor aperture 46 in at least one of the side walls 30. The pull strap may therefore be securable to the respective side wall 30 having the strap anchor aperture 46 by inserting at least one end of the pull strap into the strap anchor aperture 46. The at least one end of the pull strap may be tied into a knot configuration. When the pull strap is inserted through the strap anchor aperture 46, the knotted end may resist removal of the rope from the side wall 30 when a pulling force is applied to the rope. By securing the pull strap to the structure 10 in this way, and by attaching two or more wheels to the legs 40 as described above, the structure 10 may be pulled along the ground. When a garden waste bag is placed on the base 10, the assembled structure 10 (as shown in FIG. 6, without the pull strap) may be pulled or otherwise moved in order to transport the garden waste bag.

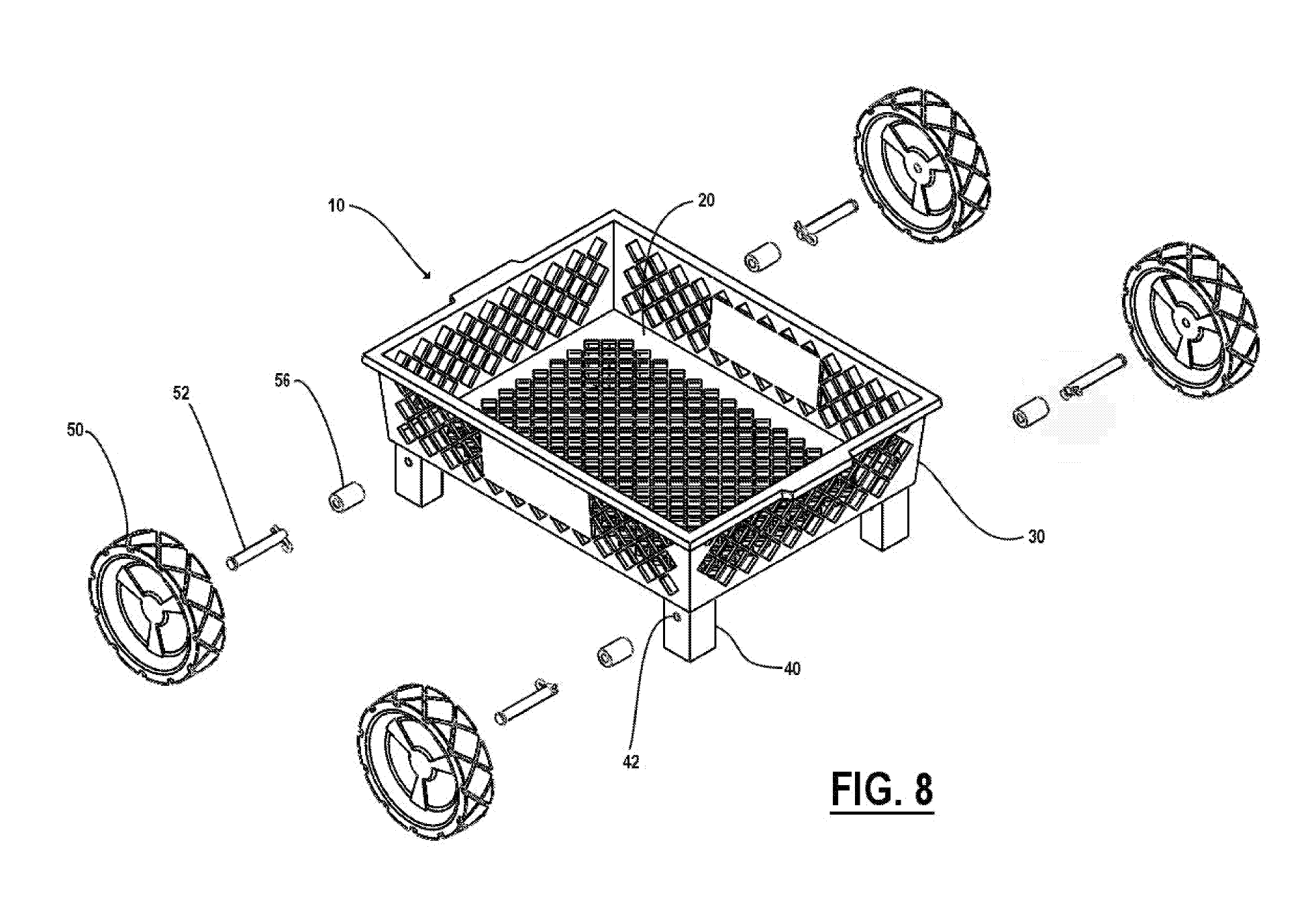

Another embodiment of the unassembled kit is shown in FIG. 8. In this embodiment, the kit may optionally include a spacer 56 for each wheel 50 to space each wheel 50 from the respective leg 40 to which it may be attached. The spacer 56 may include an elongate inner channel for receiving the attachment member 52 and allowing the attachment member to both secure to the respective leg 40 and the wheel 50, while allowing the wheel 50 to rotate.

While the structure 10 may be used to support or transport loose garden waste or bagged garden waste, the structure 10 may also be used to support or transport other items including, but not necessarily limited to: loose or bagged fertilizer; loose or bagged soil; planters; loose, bagged, or otherwise bundled firewood, and any other type of outdoor materials. Identification of the structure 10 as a garden waste storage support structure, in the claims or elsewhere in this specification is not intended to limit the structure 10 of the present invention to support or transport only a particular type of material or particular types of materials.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims. In particular, the invention is not intended to be limited to any particular size or measurement of any particular element or aspect of the invention, whether indicated in the figures or not, unless explicitly recited in the claims.

Any and all features of novelty disclosed or suggested herein, including without limitation the following:

What is claimed is:

1. A kit comprising:
a garden waste storage support structure comprising:
a base comprising a plurality of integrally formed openings therein;
a plurality of side walls extending from the base, each of the plurality of side walls comprising a plurality of integrally formed openings therein, the base and the side walls defining a structure interior; and
a plurality of support legs fixed to the base underneath the structure interior for at least partly elevating the base and the structure interior;
wherein the structure interior is sized to support a garden waste bag;
a plurality of wheels;
a plurality of attachment members, each attachment member for attaching one of the plurality of wheels to a respective one of the plurality of support legs.

2. The kit of claim 1 wherein each of the plurality of legs is fixed to the base at a respective corner of the base.

3. The kit of claim 1 wherein each of the plurality of legs comprises a mounting aperture bored laterally therethrough, and wherein each of the plurality of attachment members is sized to fit through the respective mounting aperture.

4. The kit of claim 1 wherein at least one of the plurality of attachment members comprises a clevis pin.

5. The kit of claim 1 wherein at least one of the plurality of attachment members comprises a cotter pin.

6. The kit of claim 1 wherein the plurality of integrally formed openings in the base are defined by intersections of a plurality of intersecting planar support members integrally formed into the base.

7. The kit of claim 1 wherein the plurality of integrally formed openings in each of the side walls are defined by intersections of a plurality of intersecting planar support members integrally formed into each of the side walls.

8. The kit of claim 1 further comprising a pull strap; wherein at least one of the plurality of side walls comprises a strap anchor aperture, and the pull strap is securable to the at least one of the plurality of side walls by inserting at least one end of the pull strap into the strap anchor aperture of the at least one of the plurality of side walls.

9. The kit of claim 8 wherein the pull strap comprises a rope, and the rope comprises a knot at the at least one end of the rope for resisting removal of the rope from the at least one of the plurality of side walls when a pulling force is applied to the rope.

10. A garden waste storage support structure comprising:
a base comprising a plurality of integrally formed openings therein;
a plurality of side walls extending from the base, each of the plurality of side walls comprising a plurality of integrally formed openings therein, the base and the side walls defining a structure interior; and
a plurality of support legs fixed to the base underneath the structure interior for at least partly elevating the base and the structure interior;
wherein the structure interior is sized to support a garden waste bag.

11. The garden waste storage support structure of claim 10 wherein each of the plurality of legs is fixed to the base at a respective corner of the base.

12. The garden waste storage support structure of claim 10 wherein the plurality of integrally formed openings in the base are defined by intersections of a plurality of intersecting planar support members integrally formed into the base.

13. The garden waste storage support structure of claim 10 wherein the plurality of integrally formed openings in each of the side walls are defined by intersections of a plurality of intersecting planar support members integrally formed into each of the side walls.

14. The garden waste storage support structure of claim 10 wherein at least one of the plurality of side walls comprises a strap anchor aperture for securing a pull strap thereto.
